(19) United States
(12) Patent Application Publication
(10) Pub. No.: US 2009/0208107 A1
(43) Pub. Date: Aug. 20, 2009

(54) CHARACTER RECOGNITION APPARATUS AND CHARACTER RECOGNITION METHOD

(75) Inventors: Misako Suwa, Kawasaki (JP); Katsuhito Fujimoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/371,822

(22) Filed: Feb. 16, 2009

(30) Foreign Application Priority Data
Feb. 19, 2008 (JP) 2008-36785

(51) Int. Cl. G06K 9/00

(52) U.S. Cl. 382/187

(57) ABSTRACT

A character recognition apparatus includes a division mechanism for dividing a diagram into a plurality of parts, a candidate character string acquisition mechanism for combining the plurality of parts of the diagram, and a character string selection mechanism for selecting one character string. The candidate character string acquisition mechanism includes at least one of first mechanism for duplicating a character line that touches adjacent characters and then including a duplicated character line as an element of a candidate character string, and second mechanism for including a candidate character string in which the touching character line between the adjacent characters has been removed, and a candidate character string in which the touching character line is contained, in the plurality of candidate character strings.

### CROSS-REFERENCE TO RELATED APPLICATIONS

This application is related to and claims priority to Japanese patent application no. 2008-36785 filed on Feb. 19, 2008 in the Japan Patent Office, which is incorporated by reference herein.

### FIELD

The present invention relates to character recognition apparatus and a character recognition method.

### BACKGROUND

In FIG. 1, hand-written numerals are automatically recognized by utilizing an OCR (Optical Character Reader) or the like.

FIGS. 2A to 2D show an example of how a candidate character lattice is used in the automatic recognition.

In this case, hand-written characters which consist of numerals touching each other as shown in FIG. 2A are separated via stages shown in FIGS. 2B, 2C and 2D, whereby character recognition is made.

On the other hand, when hand-written characters which consist of numerals touching each other as in an example shown in FIGS. 3A to 3D or in an example shown in FIGS. 4A to 4C are automatically recognized, a case where malrecognition occurs is supposed.

### SUMMARY

According to an aspect of the embodiments, a character recognition apparatus includes a division mechanism for dividing a diagram into a plurality of parts on the basis of the diagram obtained from a slip in which a character string has been entered. A candidate character string acquisition mechanism combines the plurality of parts of the diagram divided by the division mechanism, to obtain a plurality of candidate character strings for the character string in the diagram. A character string selection mechanism selects one character string from among the plurality of candidate character strings. The candidate character string acquisition mechanism includes at least one of a first mechanism for duplicating a character line that touches between adjacent characters and then including the duplicated character line as an element of a candidate character string, and a second mechanism for including a candidate character string in which the touching character line between the adjacent characters has been removed, and a candidate character string in which the character line is contained, in the plurality of candidate character strings.

Other features and advantages of embodiments of the invention are apparent from the detailed specification and, thus, are intended to fall within the scope of the appended claims. Further, because numerous modifications and changes will be apparent to those skilled in the art based on the description herein, it is not desired to limit the embodiments of the invention to the exact construction and operation illustrated and described, and accordingly all suitable modifications and equivalents are included.

### BRIEF DESCRIPTION OF THE DRAWINGS

FIG. 1 is a diagram of an example of a hand-written numeral string;

FIG. 2A is a diagram for a candidate character lattice;

FIG. 2B is a diagram for the candidate character lattice;

FIG. 2C is a diagram for the candidate character lattice;

FIG. 2D is a diagram for the candidate character lattice;

FIG. 3A is a diagram (#1) for the character recognition of hand-written numerals which touch each other;

FIG. 3B is a diagram (#1) for the character recognition of the hand-written numerals which touch each other;

FIG. 3C is a diagram (#1) for the character recognition of the hand-written numerals which touch each other;

FIG. 3D is a diagram (#1) for the character recognition of the hand-written numerals which touch each other;

FIG. 4A is a diagram (#2) for the character recognition of hand-written numerals which touch each other;

FIG. 4B is a diagram (#2) for the character recognition of the hand-written numerals which touch each other;

FIG. 4C is a diagram (#2) for the character recognition of the hand-written numerals which touch each other;

FIG. 5A is a diagram (#1) for the function and advantage of an embodiment;

FIG. 5B is a diagram (#1) for the function and advantage of an embodiment;

FIG. 6 is an operating flow chart of an edge touching candidate process;

FIG. 7A is a diagram (#2) for the function and advantage of an embodiment;

FIG. 7B is a diagram (#2) for the function and advantage of an embodiment;

FIG. 8 is an operating flow chart of a continuous line candidate process;

FIG. 9 is a block diagram for the configuration of a character recognition apparatus;

FIG. 10 is a block diagram for the configuration of a graphicization unit shown in FIG. 9;

FIG. 11 is a processing flow chart of the graphicization unit;

FIG. 12A is a diagram for the process of the graphicization unit;

FIG. 12B is a diagram for the process of the graphicization unit;

FIG. 12C is a diagram for the process of the graphicization unit;

FIG. 12D is a diagram for the process of the graphicization unit;

FIG. 12E is a diagram for the process of the graphicization unit;

FIG. 12F is a diagram for the process of the graphicization unit;

FIG. 13A is a diagram for mask patterns for vertex extractions;

FIG. 13B is a diagram for mask patterns for vertex extractions;

FIG. 14A is a diagram for an example of a vertex information file;

FIG. 14B is a diagram for an example of an edge information file;

FIG. 15A is a diagram for a process for obtaining the character line of edge touching candidates;

FIG. 15B is a diagram for a process for obtaining the character line of edge touching candidates;

FIG. 16A is a diagram for a process for obtaining the character line of a continuous line candidate;

FIG. 16B is a diagram for a process for obtaining the character line of a continuous line candidate;

FIG. 17A is a diagram for the creation of a candidate character lattice;

FIG. 17B is a diagram for the creation of the candidate character lattice;

FIG. 17C is a diagram for the creation of the candidate character lattice;

FIG. 17D is a diagram for the creation of the candidate character lattice;

FIG. 17E is a diagram for the creation of the candidate character lattice;

FIG. 17F is a diagram for the creation of the candidate character lattice;

FIG. 18A is a diagram for an example of a structure which expresses a lattice;

FIG. 18B is a diagram for an example of a structure which expresses an edge;

FIG. 18C is a diagram for an example of a structure which expresses a vertex;

FIG. 19A is a diagram for a shortest path search result for an example in FIGS. 17A to 17F;

FIG. 19B is a diagram for the shortest path search result for the example in FIGS. 17A to 17F; and

FIG. 20 is a block diagram of the hardware of a computer.

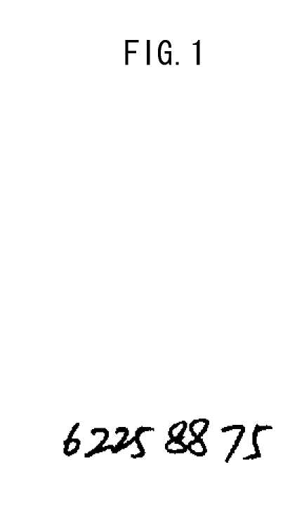

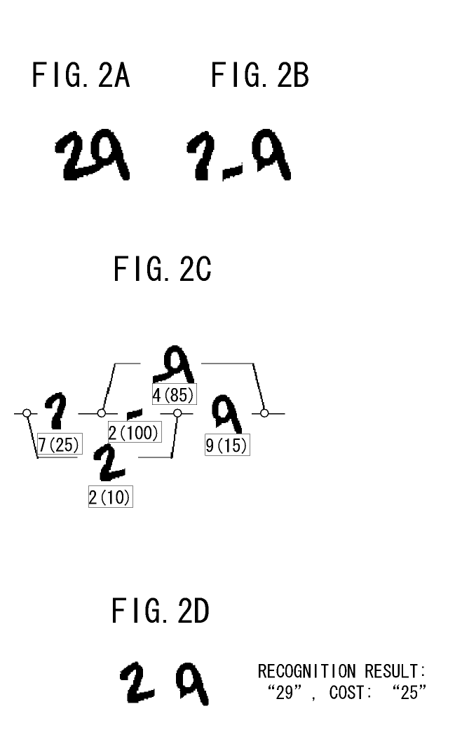

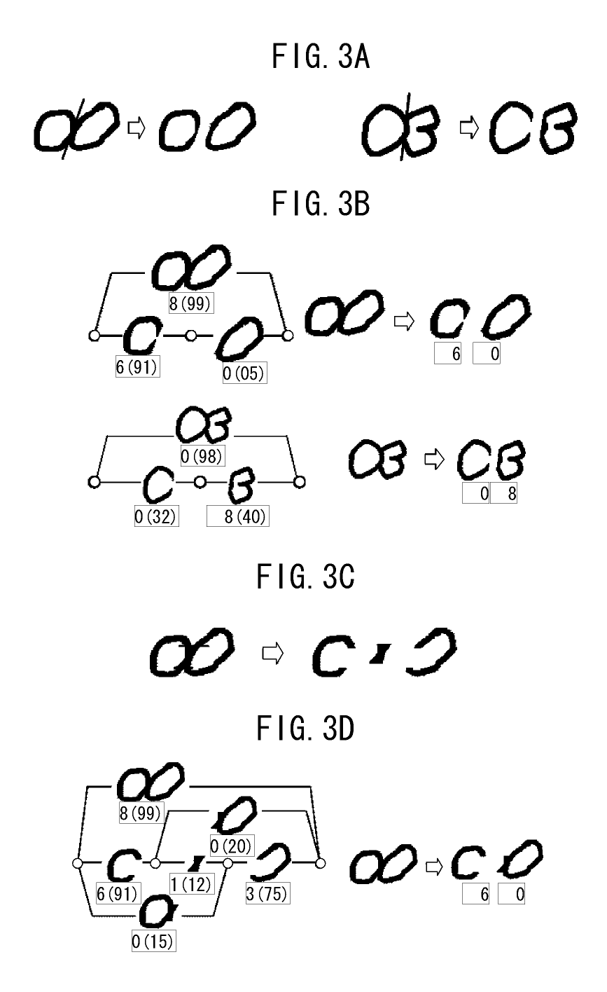

### DESCRIPTION OF EMBODIMENTS

In the embodiments, considering the possibility of confusion in character recognition, a process for removing unnecessary character lines such as the continuous line between characters, as will be explained later, or a process for separating the edge touch between characters, also to be explained later, is expressed within the candidate character lattice. A shortest path search such as the well-known dynamic programming can be systematically applied to such a process. In other words, the optimal path can be determined in consideration of the conformability of the whole character string to-be-recognized.

Here, the “path” implies a plurality of paths which are included in the candidate character lattice, and it implies paths which correspond respectively to a plurality of candidate character strings.

For example, procedures according to embodiments will be described below.

(i) When two characters which are adjacent to each other in a character string to-be-recognized touch each other in an edge touching space, candidates of a character line forming the character line in the touch space are acquired. In addition, the candidates of the character line are registered twice in a candidate character lattice.

In the candidate character lattice, consequently, it is possible to consider three sorts of possibilities; a case where the candidate of the character line is contained in the left character of the two characters adjacent to each other, a case where the candidate of the character line is contained in the right character, and a case where the candidates of the character line are contained in both of the two characters. Incidentally, the “character line” here signifies a line which constitutes the character contained in the character string to-be-recognized (as will be stated later, a “continuous line” shall also be termed the “character line” for the sake of the convenience of description). In addition, the most probable path, namely, one character string among a plurality of candidate character strings is determined on the basis of the candidate character lattice by applying the technique of the shortest search such as dynamic programming. As a result, it is possible to increase a probability that which one character string thus determined is the character string itself to-be-recognized, in other words, the possibility that a recognition result will be correct.

More specifically, even where character lines are superposed on each other between the two characters which are adjacent on the character string to-be-recognized, and where the two characters touch each other (in other words, the two characters are in an edge touching state), these two characters can be properly separated.

The following case is supposed as a case different from such a case where the character lines are superposed on each other between the two characters which are adjacent on the character string to-be-recognized and where the two characters touch each other: Two characters adjacent on a character string to-be-recognized touch each other in a state where a character line contained in one of the two characters touches the other character in two places.

There is the tendency that the former case and the latter case are difficult to distinguish in external appearances, but the distinction between both the cases is facilitated by the double registration stated above.

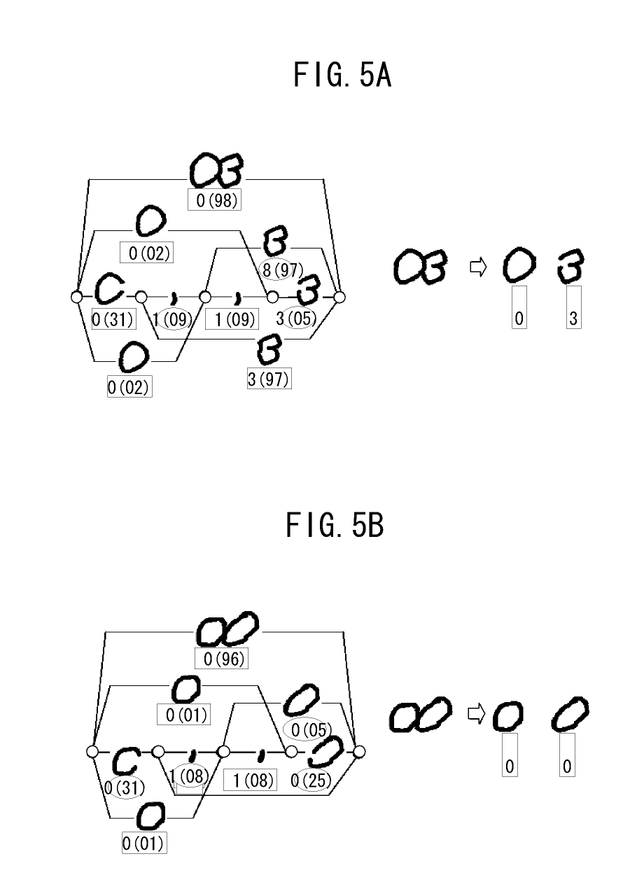

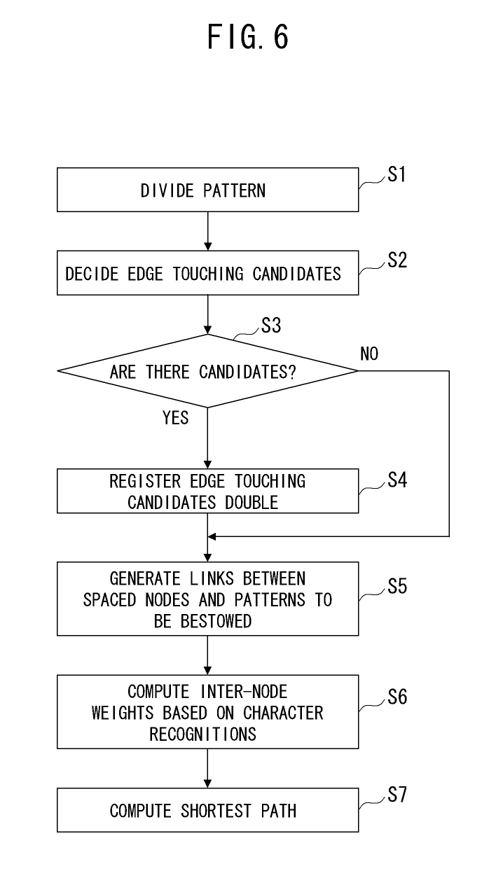

Now, a process for the double registration (hereinbelow, termed the “edge touching candidate process”) will be described by mentioning concrete examples, in conjunction with FIGS. 5A and 5B and FIG. 6.

The left side of FIG. 5A shows an example of a candidate character lattice which has been obtained in case of recognizing hand-written characters “03” as shown on the right side of FIG. 5A.

First, the creation of the candidate character lattice will be described by exemplifying the illustrated candidate character lattice.

In the candidate character lattice, a path which extends from a black dot at the leftmost end (hereinbelow, such a black dot shall be termed “node”, and the node at the leftmost end shall be termed “start node”) to a node at the rightmost end (hereinbelow, termed “end node”) corresponds to the path stated before. In the example in FIG. 5A, a plurality of paths beginning at the start node and leading to the end node are existent as understood from the configuration of the candidate character lattice in the figure. This signifies that the plurality of paths are included in the candidate character lattice, in other words, that a plurality of candidates of character strings (namely, candidate character strings) corresponding to the respective paths are included.

Each of the plurality of paths includes a link as its constituent element. In a case where the path does not include any node, the path itself is the link. In a case where the path includes nodes, the constituent element of the path as is connected by the nodes is the link.

Hereinbelow, when the individual links constituting the respective paths included in such a candidate character lattice are to be indicated, they shall be indicated by Nos. (to be explained later) affixed to the pertinent links. By way of example, in the candidate character lattice in FIG. 5A, No. 0(98) is affixed to a link at the upper most stage, and hence, this link is termed the “link 0(98)”.

Here, the link 0(98) is the link which constitutes the path corresponding to the candidate character string in the case where the hand-written characters “03” are recognized as one character in which the two characters “0” and “3” lie in touch (that is, in the case of an erroneous recognition).

The No. affixed to each link will be described below. In the No., one first digit indicates the character of a recognition result. A numerical value within succeeding parentheses indicates a cost required for the recognition (namely, a recognition cost), and as the recognition cost becomes lower, the recognition result becomes more probable. In the example of the link 0(98) at the uppermost stage, the two characters lie in touch and are recognized as one character as stated above. The recognition result is “0”, and the recognition cost in that case is “98”.

Likewise, as shown in FIG. 5A, a link 0(02) directly under the link 0(98) at the uppermost stage and a link 3(05) at a middle stage as is connected on the right side of the link 0(02) constitute another path. This path is a path corresponding to a candidate character string in the case where the hand-written characters “03” have the two characters “0” and “3” separated and where they are correctly recognized as those two characters. As will be described later, this path is a path in which the hand-written characters “03” are correctly separated, and the path corresponds to the correct recognition of “03”. Here, it is a path in the case where a character line in the touch space of the two characters touching each other has been correctly judged as a character line forming part of the character “0”. On this occasion, the “character line in the touch” is the character line of the part which constitutes the left character “0” and which extends perpendicularly on the right side. Thus, a recognition result based on this path is “0” and “3”, and a recognition cost is 02+05=07.

Likewise, a link 0(31) at the middle stage and a link 8(97) connected on the right lower side of the link 0(31) constitute still another path. This path is a path in which the hand-written characters “03” are recognized as two characters. In this case, however, the character line in the touch space of the two characters touching each other has been judged as a character line forming part of the right character “3”, unlike in the foregoing case. That is, this path is a path where the character line of the part which originally extends perpendicularly on the right side of the left character “0” as stated above has been erroneously recognized as the character line constituting the right character. A recognition result based on this path is “0” and “8”, and a recognition cost is 31+97=128. In this case, the recognition cost is clearly higher than the recognition cost 07 (namely, 7) in the above correct case, and it is indicated that a probability is lower.

Likewise, a link 0(02) at the lower stage and a link 8(97) connected on the right upper side of the link 0(02) constitute still another path. This is a path in which the hand-written characters “03” are recognized as two characters. In this case, however, the character line in the touch space of the two characters touching each other has been judged as a character line forming parts of both the characters “0” and “3”, unlike in the foregoing cases. That is, this is a path where the character line of the part which originally extends perpendicularly on the right side of the left character “0” as stated above has been recognized as belonging to both the right and left characters. Accordingly, this path corresponds to an erroneous recognition. A recognition result based on this path is “0” and “8”, and a recognition cost is 02+97=99. Also in this case, the recognition cost is clearly higher than the recognition cost 7 in the above correct case, and it is indicated that a probability is lower.

In this manner, in the character recognition using a candidate character lattice, a plurality of candidate character strings for read hand-written characters are acquired from the configuration of a diagram forming the hand-written characters. In addition, the candidate character strings are respectively associated with paths which constitute the candidate character lattice. Thereafter, the probabilities of the respective paths, namely, the probabilities of the corresponding candidate character strings, are evaluated with recognition costs. As will be seen later, the evaluations are incarnated by weighting the individual links of the paths. One path, namely, one candidate character string is selected on the basis of the results of the evaluations. Here, the technique of the shortest path search can be utilized for selecting the path. The selected candidate character string is obtained as the recognition result of the read hand-written characters.

In accordance with the method of the embodiment, as stated above, even in the case where the two characters lie in touch as in the example in FIG. 5A, the paths corresponding to all the cases supposed as the possibilities of actual characters can be included in the candidate character lattice. That is, in the case of the example in FIG. 5A, the paths corresponding to the respective cases where the character line in the mutual touch of both characters belongs to any of the characters, that is, the path of the links 0(02) and 3(05) and the path of the links 0(31) and 8(97) are included in the candidate character lattice. Further, the path corresponding to the case where the character line belongs to both the characters, that is, the path of the links 0(02) and 8(97), is included. As a result, the correct path is reliably included in the candidate character lattice, so that the precision of the character recognition can be effectively enhanced.

In this manner, with the method of the embodiment, on such an occasion where the two characters lie in touch, the paths corresponding to all the cases supposed as the possibilities of the actual characters, that is, the respective cases of the following three sorts can be included in the candidate character lattice: (1) a case where the character line in the mutual touch of both the characters belongs to the character on the left side, (2) a case where the character line belongs to the character on the right side, and (3) a case where the character line belongs to both the characters (in other words, the case of edge contact). The reason why the paths corresponding respectively to the three sorts of cases in total can be included in the candidate character lattice in this manner, will be described below.

In the example in FIG. 5A, two links 1(09) connected serially are included in the candidate character lattice as links which correspond to the character line in the mutual touch space of both the characters. As a result, in such a case where the two characters touch, the paths corresponding to the respective cases of the three possibilities of the actual characters can be included.

More concretely, in the candidate character lattice in FIG. 5A, there are obtained three nodes in total; nodes at both the ends of the two links 1(09) connected serially and a node in the mutual connection that corresponds to the character line that mutually touches both characters. In addition, the path passing through the left one of the three nodes corresponds to the above case (2), that is, the case where the character line in the mutual touch of both characters belongs to the right character. Likewise, the path passing through the middle one of the three nodes corresponds to the above case (3), that is, the case where the character line in the mutual touch of both characters belongs to both characters. Also, the path passing through the right one of the three nodes corresponds to the above case (1), that is, the case where the character line in the mutual touch of both characters belongs to the left character (that is, the correct path).

FIG. 5B shows another example of a hand-written character string. As in the case of the example in FIG. 5A, two links 1(08) connected serially are included in a candidate character lattice as links which correspond to a character line that mutually touches both characters. As a result, as in the case of the example in FIG. 5A, paths corresponding to the respective cases of three sorts supposed as the possibilities of actual characters in the case where the two characters lie in touch can be included in the candidate character lattice.

FIG. 6 shows the processing flow of the edge touching candidate process in the method of the above embodiment.

Referring to FIG. 6, at a step S1 (pattern division) the process divides a diagram into a plurality of sections on the basis of the diagram obtained from a read character image. In the case of the example in FIG. 5A, the process divides the diagram of the read hand-written characters “03” into sections such as character lines affixed to the respective links 0(02) 3(05), 0(31), 8(97) and 1(09) which constitute the candidate character string lattice in FIG. 5A.

Incidentally, the diagram has been obtained by scanning and photographing, for example, a slip of paper, in which the character string has been entered.

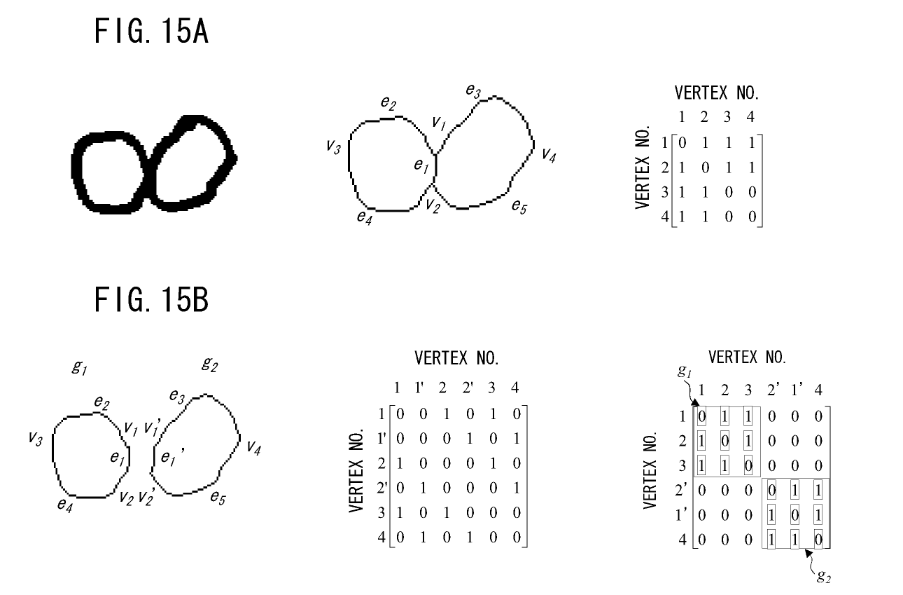

Subsequently, at a step S2 (edge touching candidate decision), the process decides whether or not a character line in the touch space of the two characters belongs to both characters can be supposed as stated above. A decision method in this case will be seen later in conjunction with FIGS. 15A and 15B.

When, as the result (step S3) of the decision, the case where the character line in the touch space belongs to both characters can be supposed, the process proceeds to a step S4, and when not, the process proceeds to a step S5 directly by skipping the step S4.

At the step S4, the character line in the touch space is registered twice. More specifically, in the example in FIG. 5A, the two links 1(09) which correspond to the character line in the touch space are serially connected and are included in the candidate character lattice.

At the step S5, regarding the candidate character lattice thus generated, corresponding character recognition results are obtained for individual links included in the candidate character lattice. In the example in FIG. 5A, in the No. affixed to each link, the No. of the first digit is the character recognition result.

Subsequently, at a step S6, the process computes recognition costs required for the character recognitions, as to the respective links.

Lastly, at a step S7, the process determines the most probable path among paths included in the candidate character lattice, on the basis of the recognition costs of the respective links as calculated at the step S6, by the technique of the shortest path search or the like, and it obtains a corresponding candidate character string as a character recognition result.

(ii) Besides, in this embodiment, a continuous line candidate process may well be conjointly performed. The continuous line candidate process will be described below.

When two characters adjacent to each other in a character string to-be-recognized touch through a continuous line (to be described later), a candidate of the character line forming the touch is acquired. In addition, a link which detours a link corresponding to the candidate of the character line is added in a candidate character lattice. Besides, a blank image (hereinbelow, also termed “NULL image”) is associated with the added link. The recognition character species of the NULL image is φ (NULL), and a recognition cost d can be appropriately determined by an experiment. As a result, the removal of the continuous line can be incarnated within the frame of the technique of the candidate character lattice using the shortest path search based on dynamic programming or the like. Further, a decision as to whether the corresponding character line is the continuous line or a lateral character line (to be described later) which is difficult to distinguish from the continuous line, is processible within a frame common to a process for any other character line constituting a character string to-be-recognized.

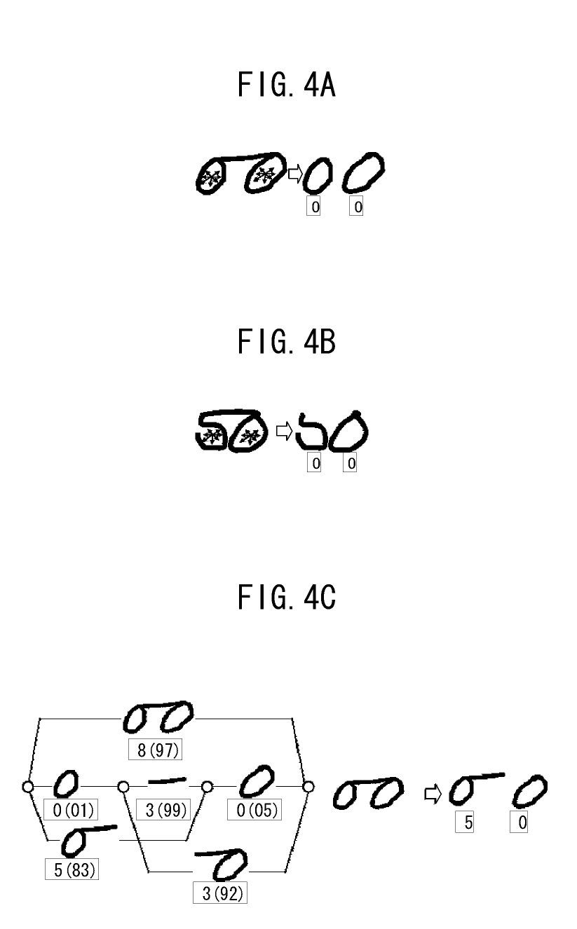

The continuous line and the lateral character line will be described in conjunction with FIGS. 4A to 4C.

FIG. 4A shows the hand-written characters of a character string “00” which consists of two numerals. As shown in the figure, in the hand-written characters, a character line which extends horizontally so as to bring both characters into touch is existent at the upper part of the space between both the characters “00”. The character line is the continuous line. That is, the character line does not form part of the characters “00”, but it is a line depicted in such a way that a writing tool slides on paper in the course of hand-writing. Accordingly, the continuous line ought to be removed in character recognition. Incidentally, the continuous line does not constitute any character as stated above, but it shall be described as the character line for the convenience of the description.

FIG. 4B shows the hand-written characters of a character string “50” which consists of two numerals. As shown in the figure, in the hand-written characters, the right end of a character line which forms the uppermost part of the numeral “5” in both the characters “50” and which extends horizontally lies in touch with the upper end of the next numeral “0”. This character line is the lateral character line. The lateral character line came into touch with the next numeral “0” for the reason that, when writing shifted from the first numeral “5” to the next numeral “0” in the course of hand-writing, a writing tool was not lifted from the paper. Unlike the continuous line, the lateral character line is a character line forming part of the first character “5”, and hence, it ought to be considered in character recognition. Since, however, the lateral character line is difficult of distinction from the continuous line in its external shape as stated above, a case where the lateral character line is erroneously removed to cause malrecognition is supposed.

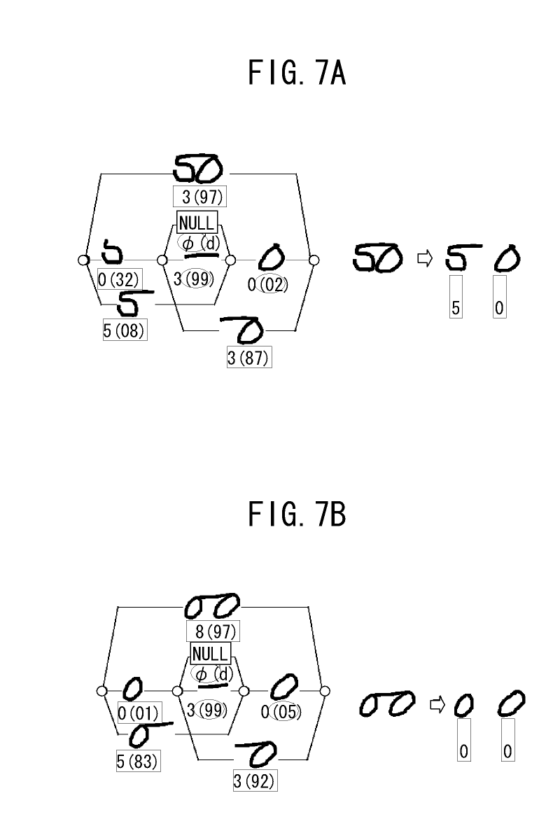

FIGS. 7A and 7B show examples of candidate character lattices in the case where, in the continuous line candidate process, a link associated with a NULL image is added to the character line of a continuous line candidate.

The left side of FIG. 7A exemplifies the candidate character lattice obtained for the hand-written character string “50” of the example in FIG. 4B. In the candidate character lattice, a link 3(99) at the middle part of a middle stage is a link which corresponds to a character line extending horizontally and which is the candidate of the continuous line. As shown in the figure, a link φ(d) corresponding to the NULL image is provided so as to detour the link 3(99). Here, the NULL image is a blank image as stated before. As a result, in a path which has the link φ(d) corresponding to the NULL image, this link is merely a detouring link. The candidate character lattice includes the two paths of a path having the link 3(99) of the candidate of the continuous line, and the path having the link φ(d) of the NULL image as detours the link 3(99). As a result, the two cases where the candidate of the continuous line is the continuous line (that is, the case of the example in FIG. 4A) and where it is the lateral character line (that is, the case of the example in FIG. 4B) can be processed by indiscriminately incorporating them into the technique of the shortest path search based on the dynamic programming. Consequently, the two cases are correctly evaluated, and the possibility of malrecognition can be effectively lowered.

In the case of the example in FIG. 7A, as stated above, the candidate of the continuous line to which the link 3(99) corresponds is actually the character line being the constituent element of the numeral “5”, and it is the lateral character line. In accordance with the candidate character lattice, the case where the candidate of the continuous line is the continuous line and the case where it is the lateral character line are indiscriminately evaluated as stated above. As a result, if a total recognition cost becomes smaller in the path having the link 3(99) of the candidate of the continuous line, than in the path having the link φ(d) of the NULL image, then a possibility at which the path having the link 3(99) of the candidate of the continuous line will be selected heightens more. That is, a possibility at which the character string will be correctly recognized as “50” as shown on the right side of FIG. 7A increases more. In addition, the recognition cost d of the NULL image can be obtained by an experiment or the like as stated above, so that such a result may be obtained.

The left side of FIG. 7B shows an example of a candidate character lattice obtained for an example in which a character string to-be-recognized is “00” similar to that in FIG. 4B. In case of the example in FIG. 7B, as stated above, the candidate of a continuous line to which a link 3(99) corresponds is a character line being a continuous line by which the two numerals “00” constituting the character string are brought into touch with each other. In accordance with the candidate character lattice, as stated above, a case where the candidate of the continuous line is actually the continuous line and a case where it is a lateral character line are both evaluated. As a result, if a total recognition cost becomes smaller in a path having the link φ(d) of a NULL image, than in a path having the link 3(99) of the candidate of the continuous line, then a possibility at which the path having the NULL image φ(d) will be selected is higher. In this path, the link 3(99) of the candidate of the continuous line is detoured by the link φ(d) of the NULL image, so that the character line of the candidate of the continuous line is removed. Accordingly, when this path is selected, a possibility at which the character string will be correctly recognized as “00” as shown on the right side of FIG. 7B increases more. In addition, the recognition cost d of the NULL image can be obtained by an experiment or the like as stated above, so that such a result may be obtained.

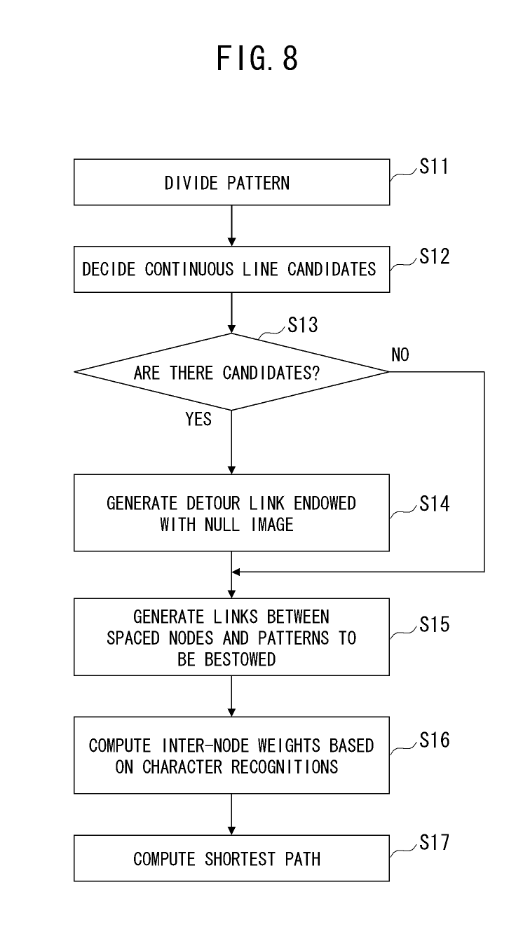

The processing flow of the continuous line candidate process in this embodiment is shown in FIG. 8.

Referring to FIG. 8, steps S11 to S17 correspond to the steps S1 to S7 in the foregoing flow chart of FIG. 6, respectively. Among them, the steps S11 and S15 to S17 are identical to the steps S1 and S5 to S7 in FIG. 6, respectively, except that the steps S12 to S14 differ from the steps S2 to S4. Accordingly, only the different steps S12 to S14 will be described, and the other steps shall be omitted from repeated description.

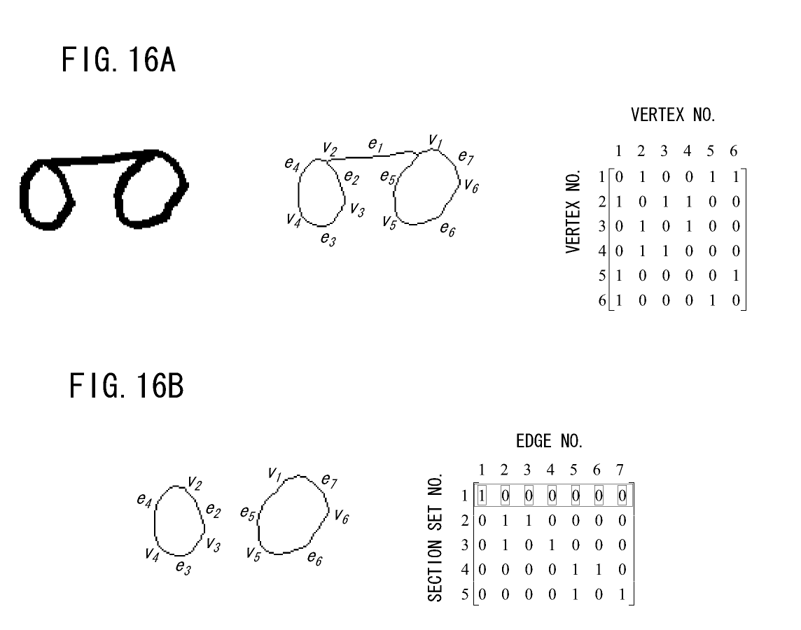

At the step S12 (continuous line candidate decision) the process decides whether or not a case where a character line that touches two characters is a continuous line can be supposed as stated above. A decision method in this case will be stated later in conjunction with FIGS. 16A and 16B.

When, as the result (step S13) of the decision, the case where the character line touching of the two characters is the continuous line, the process proceeds to the step S14, and when not, the process proceeds to the step S15 directly by skipping the step S14.

At the step S14, the process generates a link associated with a NULL image (namely, the link φ(d) stated above) as detours [???] the character line in the touch of the two characters touching each other and being adjacent in a character string to-be-recognized, that is, the candidate character string of the continuous line. More specifically, in the example of FIG. 7A, the process provides the link associated with the NULL image, as the link which is connected in parallel with the link 3(99) that corresponds to the character line in the touch of the two characters touching each other, and it includes the link of the NULL image in the candidate character lattice.

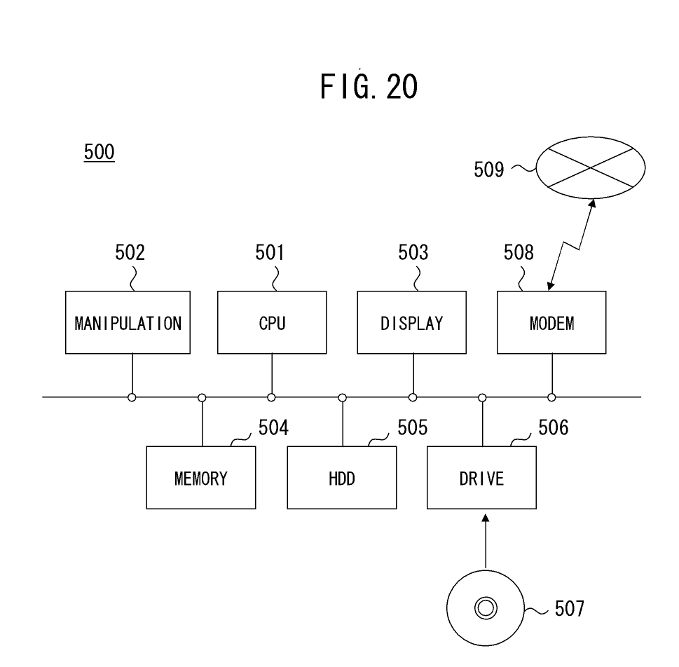

Incidentally, the respective processes stated above in conjunction with FIG. 6 and FIG. 8 can be incarnated using a computer which has a configuration as shown in FIG. 20. More specifically, as will be seen later, a program for causing the CPU of the computer to execute each of the processes is prepared, and a scanner (not shown) for reading a character image is connected to the computer. In addition, the CPU successively executes instructions stated in the program, on the basis of the character image read by the scanner, whereby the process in FIG. 6 or FIG. 8 is executed. Here, the technique of the well-known OCR can be utilized as a process for obtaining a diagram on the basis of the character image read with the scanner.

In accordance with this embodiment, in a character recognition apparatus which recognizes characters in image data that have been freely entered from a image data or the like, especially into an area having no character frame, by optical image input means, a candidate character lattice generation unit is included. In the candidate lattice generation unit, whether or not a character line or part thereof as might be superposed (that is, a character line in an edge touch or part thereof) is previously identified to form edge touching candidates, as stated before in conjunction with FIGS. 5A and 5B and FIG. 6. In addition, the pattern of the character line or the part thereof (that is, a diagram) as has been decided to form the edge touching candidates is registered twice in the lattice. Besides, the links between the nodes of the lattice are given weights based on recognition costs (scores) by the character recognition. Subsequently, the path of the shortest distance (the path of the longest distance in the case of the scores) is obtained by the dynamic programming on the basis of the weights. As a result, the edge touch between the adjacent characters can be separated in consideration of the whole conformability within the frame of the technique of the candidate character lattice using the dynamic programming.

Besides, in accordance with this embodiment, in a character recognition apparatus which recognizes characters in image data that have been freely entered from a slip image or the like, especially into an area having no character frame, by optical image input means, a candidate character lattice generation unit is included. In the candidate character lattice generation unit, whether or not a character line candidate which might be a continuous line is the candidate of the continuous line is previously identified, and a pattern corresponding to the character line (that is, a diagram) as has been found to be the continuous line candidate is registered as the link between the nodes of the lattice, as stated before in conjunction with FIGS. 7A and 7B and FIG. 8. On that occasion, a link which detours the above link is set between the nodes, and a NULL image is registered in the set link. As a result, the continuous line which is unnecessary for the character recognition can be removed in consideration of the whole conformability within the frame of the technique of the candidate character lattice using the dynamic programming.

As processes executable in this embodiment, a process in which the character line of the edge touching candidates is registered twice and included in the candidate character lattice (the process shall be termed “process by first means”) has been described in conjunction with FIGS. 5A and 5B and FIG. 6. Further, a process in which the link detouring the candidate of the continuous line is registered and included in the candidate character lattice (the process shall be termed “process by second means”) has been described in conjunction with FIGS. 7A and 7B and FIG. 8. In the embodiment, only either of the process by the first means and the process by the second means may well be carried out. Besides, in the embodiment, both of the process by the first means and the process by the second means may well be conjointly carried out.

Besides, in the process by the second means, a weight corresponding to the NULL image between the nodes as has been provided so as to detour that link between the nodes for which the candidate of the continuous line is registered in the candidate character lattice can be appropriately set by an experiment.

Now, the configuration of the embodiment will be described in more detail.

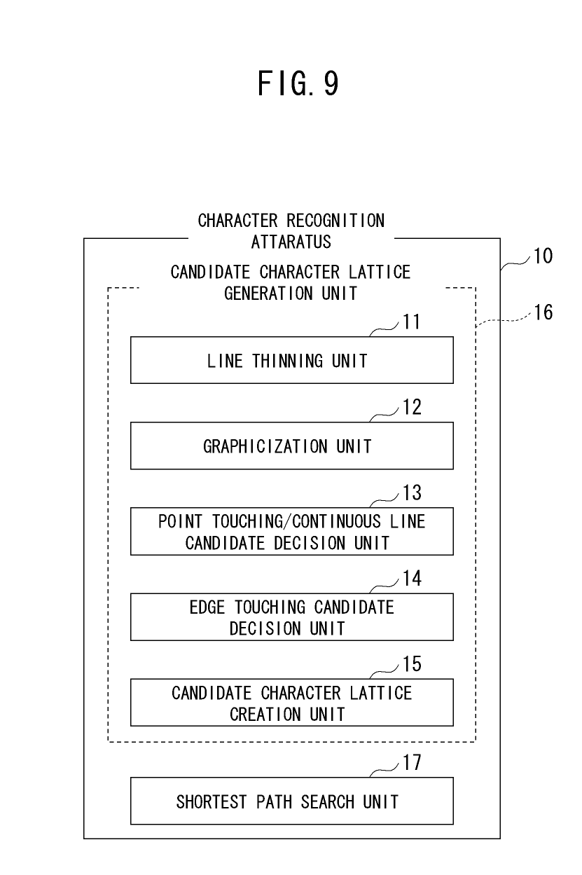

FIG. 9 shows the general configuration of the character recognition apparatus according to this embodiment.

The character recognition apparatus 10 accepts the image of a slip of paper or the like and turns the image into electronic data by a scanner, and it converts the electronic data into a black-and-white binary image. Further, the apparatus 10 segments a character string, and it decides a touching pattern which indicates the touch state between character lines contained in the character string. These processes can be incarnated by utilizing existent techniques.

In this embodiment, in a case where the touching pattern has been obtained, a process for segmenting characters one by one and recognizing them is executed.

The character recognition apparatus 10 broadly includes a candidate character lattice generation unit 16 and a shortest path search unit 17. Further, the candidate character lattice generation unit 16 includes a line thinning unit 11, a graphicization unit 12, a point touching/continuous line candidate decision unit 13, an edge touching candidate decision unit 14, and a candidate character lattice creation unit 15.

The line thinning unit 11 converts an inputted binary touching pattern into a line-thinned pattern whose line width is one (pixel), by an existing technique. As will be detailed later, the graphicization unit 12 extracts vertexes and edges from the line-thinned pattern and obtains the adjacency and connection relations of the vertexes and edges, thereby to express the line-thinned pattern (that is, a diagram) as a graph.

The point touching/continuous line candidate decision unit 13 and the edge touching candidate decision unit 14 identifies the edge of the candidate of a point touch, the edge of the candidate of a continuous line, and the edge of the candidate of an edge touch, from the individual edges of the graph. The candidate character lattice creation unit 15 divides the graph into the partial sets of the edges, and registers them in a candidate character lattice in conformity with the rules of the respective partial sets. In addition, the candidate character lattice creation unit 15 connects nodes capable of generating the patterns of recognition character candidates, by links, and it generates the patterns of the recognition character candidates from the partial sets of the edges set between the nodes.

Further, the candidate character lattice creation unit 15 actually executes character recognitions for the patterns of the recognition character candidates as have been thus generated by utilizing existent techniques. In addition, the candidate character lattice creation unit 15 determines the weights of the links from the difference degrees of character recognition results. For the candidate character lattice generated in the above way, the shortest path search unit 17 obtains the shortest path by a well-known method such as the dynamic programming or the Dijkstra method, thereby to obtain a final character recognition result.

Next, the process of the graphicization unit 12 will be described in detail.

The graphicization unit 12 expresses the line-thinned pattern (that is, the diagram) into which a read image has been subjected to the line thinning and which has been obtained by the line thinning unit 11, as a graph by using an existent technique.

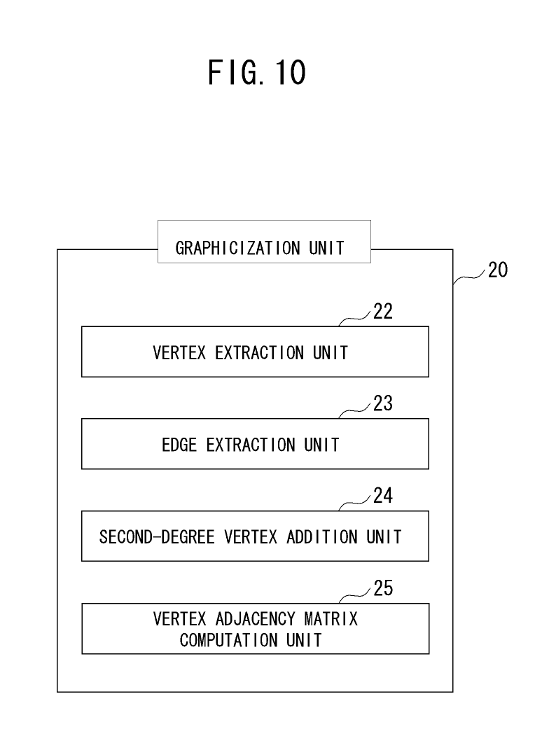

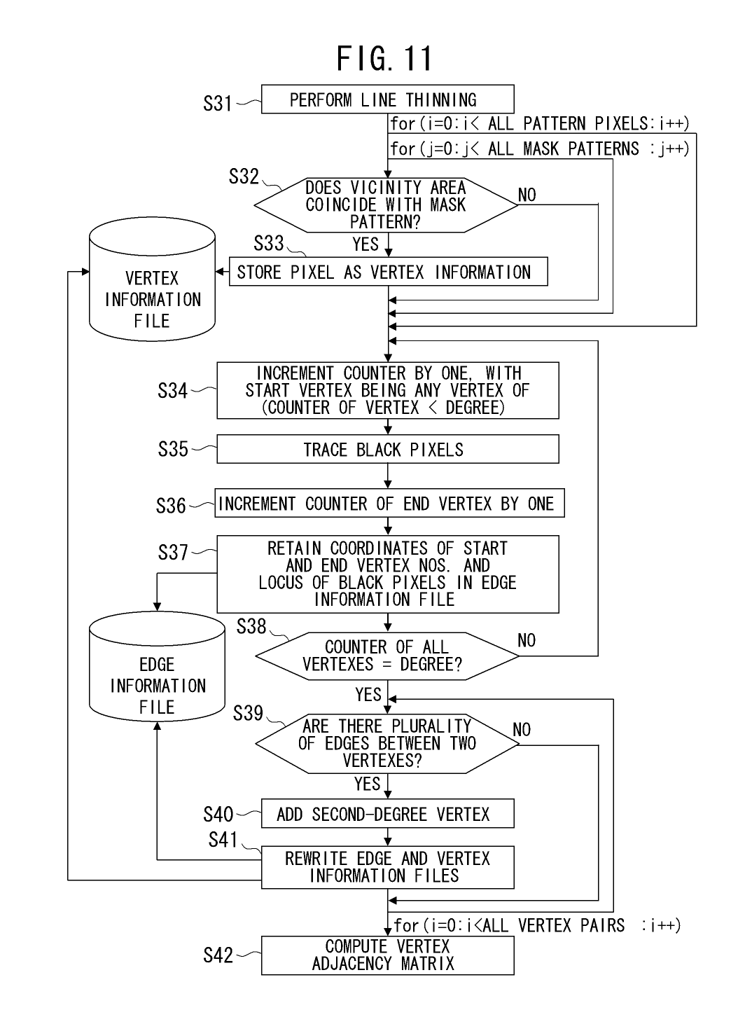

FIG. 10 shows the internal configuration of the graphicization unit 12. FIG. 11 shows a flow chart of the process based on the graphicization unit 12.

As shown in FIG. 10, the graphicization unit 12 includes a vertex extraction unit 22, an edge extraction unit 23, a second-degree vertex addition unit 24, and a vertex adjacency matrix computation unit 25.

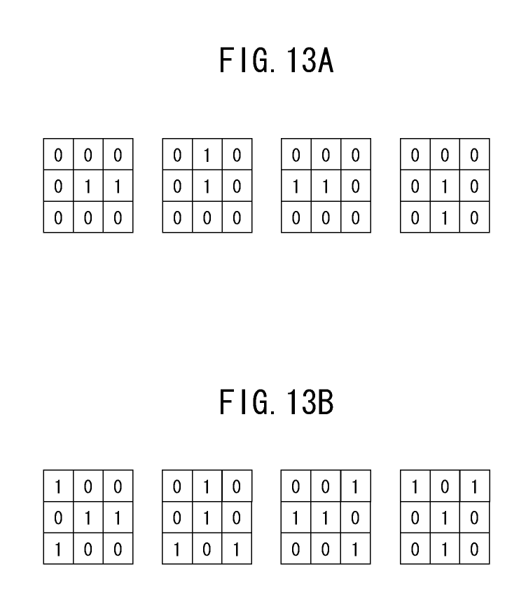

As stated above, the pattern of the image (namely, read image) of a character string to-be-recognized read by a scanner or the like is subjected to line thinning by the line thinning unit 11, whereby a line-thinned pattern is obtained (step S31 in FIG. 11). The vertex extraction unit 22 checks the 8-vicinity area of each pixel of the line-thinned pattern, and it examines whether or not the 8-vicinity area coincides with a mask pattern of (3×3) size (refer to FIGS. 13A and 13B) prepared for the extraction of the vertex of each degree beforehand (step S32). In a case where the 8-vicinity area coincides with the mask pattern, the pertinent pixel is stored as the vertex of the degree indicated by the mask pattern (step S33). Here, the “degree of the vertex” signifies the number of edges connected to the vertex. The positional coordinates of the vertex thus extracted are retained in a vertex information file.

The edge extraction unit 23 prepares counters for the respective vertexes, and initializes the counters with zero. First, one desired vertex as to which the value of the counter is smaller than the degree of the edge is selected, and the counter of the pertinent vertex is incremented by one (step S34). The pertinent vertex is set as a start vertex, and black pixels on the line-thinned pattern are traced from the start vertex until another vertex is reached (step S35). The other vertex shall be called the “end vertex”. The counter of the end vertex is incremented by one (step S36).

The coordinates of the traced black pixels, the No. of the start vertex and the No. of the end vertex are retained as edge information (step S37). Such edge extractions are continued until the counters of all the vertexes become equal to the degrees thereof (“Yes” at a step S38).

The edge is obtained in such a way that, on the line-thinned pattern, the black pixels are traced by starting at the certain vertex, until the other vertex is reached. The No. of the edge, the locus of the positional coordinates of the black pixels between the vertexes, and the Nos. of the vertexes connected to the edge are retained in the edge information file.

Further, the second-degree vertex addition unit 24 checks the pairs of all the vertexes, and where the number of the edges connected between two vertexes is, at least, two (“Yes” at a step S39), a second-degree vertex is added to any edge other than the shortest edge (step S40). As a result, the edge is generated anew, and hence, the vertex information file and the information file of the edges are rewritten (step S41).

The vertex adjacency matrix computation unit 25 computes a vertex adjacency matrix from the edge information thus obtained. Here, the “vertex adjacency matrix” is a matrix whose element has a value “1” in a case where the vertexes are connected by the edge, and a value “0” in a case where they are not connected.

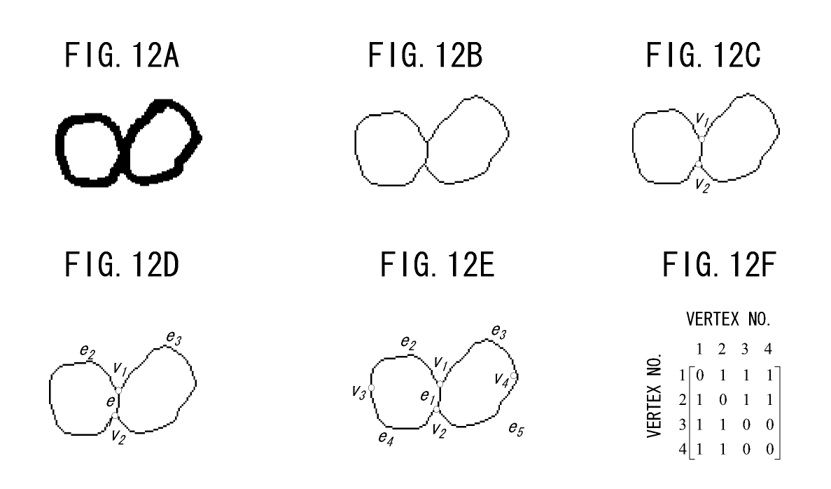

FIGS. 12A to 12F conceptually show the data which are outputted by the line thinning unit 11 shown in FIG. 9 and the constituent units 22 to 25 of the graphicization unit 12 shown in FIG. 10.

FIG. 12A shows an example of a read image which has been read by a scanner. FIG. 12B shows an example of a line-thinned pattern (that is, a diagram) subjected to line thinning by the line thinning unit 11. FIG. 12C shows a situation where vertexes v1 and v2 have been extracted by the vertex extraction unit 22. FIG. 12D shows a situation where edges e1, e2 and e3 have been extracted by the edge extraction unit 23. FIG. 12E shows a situation where second-degree vertexes e4 and e5 and attendant second-degree vertexes v3 and v4 have been added by the second-degree vertex addition unit 24. FIG. 12F shows an example of a vertex adjacency matrix obtained by the vertex adjacency matrix computation unit 25.

FIGS. 13A and 13B exemplify some mask patterns for extracting vertexes of degrees “1” and “3”, among the mask patterns stated above. In the figures, “1” expresses a black pixel, and “0” expresses a white pixel.

FIG. 13A shows examples of the mask patterns for extracting the vertexes of degree “1”. FIG. 13B shows examples of the mask patterns for extracting the vertexes of degree “3”.

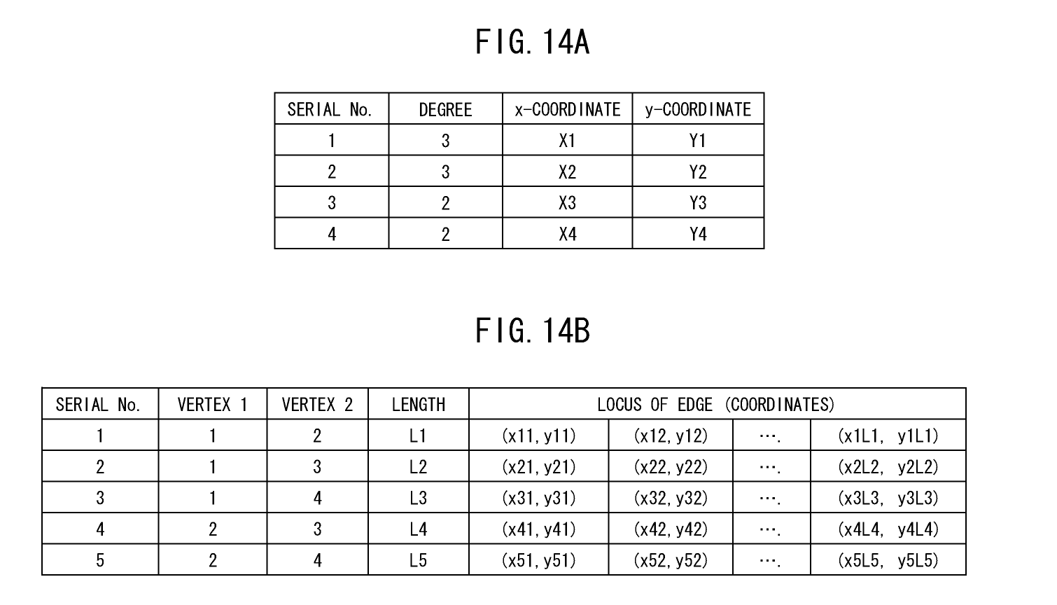

FIGS. 14A and 14B show examples of a vertex information file and an edge information file which have been finally obtained, respectively. FIG. 14A exemplifies the vertex information file, while FIG. 14B exemplifies the edge information file.

Next, the edge touching candidate decision process of the edge touching candidate decision unit 14 shown in FIG. 9 will be described in detail with reference to FIGS. 15A and 15B. FIG. 15A shows diagrams similar to FIGS. 12A, 12B and 12C referred to above.

The candidates of the edge touch of the character line of adjacent characters in the touching pattern are determined as stated below.

(i) The edges of all graphs are checked, and the edges which do not meet certain conditions are removed, whereby the candidates are narrowed down. In case of the edge touch, the edge of the corresponding graph satisfies conditions as stated below by way of example, and hence, the other edges are removed from the candidates of the edge touch. (Condition #1) The degree of the respective vertexes connected to the pertinent edge is, at least, “3” (letter T or cross). (Condition #2) The gradient of the pertinent edge is, at least, a threshold value (perpendicular or oblique), for example, a height to a width is at least one. That is, the pertinent edge is substantially perpendicular to the extending direction of the pertinent character string.

In the example in FIG. 15A, it is only the edge e1 that agrees with the conditions #1 and #2. Accordingly, the edge e1 is obtained as the candidate of the edge touch. More specifically, the edge e1 has the vertexes v1 and v2, and since each of the vertexes v1 and v2 has the touch of T-shape, its degree is “3”, so that the condition #1 is satisfied. Besides, since the edge e1 extends substantially perpendicularly, the ratio of the height to the width becomes at least one, so that the condition #2 is also satisfied. The other edges e2 to e5 do not satisfy these conditions. By way of example, in FIG. 15A, the edge e2 does not satisfy the condition #1 because the degree of its vertex v3 is “2”.

(ii) Further, for the edges of the graph, the edge of the edge touching candidate and the vertexes connected thereto are duplicated using the vertex adjacency matrix, and the adjacent edges are appropriately divided, thereby to decide whether or not the graph is separated into two.

FIG. 15B shows a situation where the edge e1 of the edge touching candidate and the vertexes v1 and v2 connected thereto have been duplicated. Such duplication of the edge and the vertexes is concretely performed as stated below.

In the example in FIG. 15B, as shown in the middle of the figure, new rows 1′ and 2′ and columns 1′ and 2′ are respectively inserted adjacent to rows 1 and 2 and columns 1 and 2 which correspond to the vertexes v1 and v2 connected to the edge e1 to-be-duplicated, in the vertex adjacency matrix of the graph.

Subsequently, the x-coordinates of the other vertexes of edges other than the duplicated edge as are connected to the vertexes v1′ and v2′ thus duplicated (that is, coordinates on a coordinate axis along the extending direction of the character string) are compared with each other, and the edges are determined so as to be connected to either of the duplicated vertexes. In the example in FIG. 15B, the edges e2 and e3 are connected to the vertex v1 connected to the edge e1. In this case, letting “x3” and “x4” denote the x-coordinates of the other vertexes v3 and v4 of the edges e2 and e3, respectively, and letting “x1” denote the x-coordinate of the vertex v1, x3<x1 holds, so that the edge e2 has its connection with the vertex v1′ cut off to be made adjacent to only the left duplicated edge e1, and x4>x1 holds, so that the edge e4 has its connection with the vertex v1 cut off to be made adjacent to only the right duplicated edge e1′. That is, in the vertex adjacency matrix, the matrix element between the vertexes v4 and v1′ is set at “1”, the matrix element between the vertexes v4 and v1 is set at “0”, the matrix element between the vertexes v3 and v1 is set at “1”, and the matrix element between the vertexes v3 and v1′ is set at “0”. The edges other than the edge e1 to-be-handled, and the adjacency relations between the vertexes other than the vertexes v1 and v2 connected to the edge e1, are held as they are. An example of the new vertex adjacency matrix in the case where the new edge e1′ is thus generated by duplicating the edge e1 to-be-handled, is shown in the middle of FIG. 15B.

Subsequently, it is decided whether or not a matrix becomes a block-diagonal form in a case where the rows and columns of the vertex adjacency matrix thus obtained are appropriately replaced. The right side of FIG. 15B shows a situation where the rows and columns of the vertex adjacency matrix have been appropriately replaced, with the result that the matrix has become the block-diagonal form. In a case where the vertex adjacency matrix has become the block-diagonal form in this manner, it is deemed that the graph is separated into two subgraphs g1 and g2 by the duplication of the edge. Vertexes corresponding to respective blocks correspond to vertexes which the respective partial graphs have.

In this way, as shown on the left side of FIG. 15B, the graph shown in the middle of FIG. 15A is separated into the two subgraphs g1 and g2. In addition, the edge e1 of the edge touching candidate is duplicated, and it is registered and included as character lines which belong to the two subgraphs g1 and g2, respectively. In other words, the edge e1 of the edge touching candidate is registered twice (in correspondence with the step S4 in FIG. 6).

Next, the process of the point touching/continuous line candidate decision unit 13 shown in FIG. 9 will be detailed in conjunction with FIGS. 16A and 16B.

The candidate of a continuous line is determined by a procedure stated below, and a pattern (that is, a diagram) is separated. (i) The line-thinned pattern of a read image as subjected to line thinning is graphicized by the above method, and a vertex adjacency matrix similar to the above is obtained. Using the vertex adjacency matrix, the section set basic matrix of an edge is obtained from the vertex adjacency matrix by the technique of a graph theory. Here, the “section set basic matrix of an edge” is a matrix in which respective rows express section sets and whose elements are edges corresponding to Nos. where the components of the section sets become “1”. Here, the expression “section sets” signifies such section sets that, when the edges of the elements thereof are removed from the graph, the pertinent graph is separated into two. In case of an example of the vertex adjacency matrix shown on the right side of FIG. 16A, the section basic set matrix shown on the right side of FIG. 16B is obtained. By way of example, the section set basic matrix of section set No. “1” as contained in the section basic set matrix has an element number of “1”, and it has an edge e1 of edge No. “1” as a corresponding element. In this section set, when the edge e1 is removed, the original graph shown in the middle of FIG. 16A is separated into two partial graphs as shown on the left side of FIG. 16B. Likewise, the section set basic matrix of section set No. “3” has an element number of “2”, and it has edges e2 and e4 of edge Nos. “2” and “4” as corresponding elements. In this section set, when the edges e2 and e4 are removed, the original graph shown in the middle of FIG. 16A is separated into the partial graph of an edge e3 and the partial graph of edges e1, e5, e6 and e7.

The candidates of the continuous line to be obtained here are included in these section sets. (ii) In order to obtain the edges of the candidates of the continuous line, the candidates are narrowed down by rules as stated below, for respective section set bases. First, the edges of the candidates of point touches are obtained. (Condition #1) Edge belonging to the section set whose element number is “1”. (Condition #2) Edge having a gradient which is, at most, a threshold value (horizontal), for example, an edge as to which the ratio of a height to a width is, at most, one. That is, an edge which is substantially parallel to the extending direction of the character string.

As regards the edges of the point touching candidates thus narrowed down, edges which further satisfy rules stated below are obtained as the edges of the candidates of the continuous line. (Condition #3) Edge in which the y-coordinate of the centroid thereof (that is, a coordinate on a coordinate axis orthogonal to the extending direction of the character string) is at a position that is, at most, the threshold value of the height of a pattern (that is, the whole diagram, and the same shall apply below), for example, edge whose centroid exists at, at most, ⅓ of the height of the pattern. In this case, the origin of coordinates is set at a left upper position, and the expression “at most the threshold value” or “at most ⅓” signifies that the centroid lies on an upper side above the threshold value, or within ⅓ of the upper side of the pattern. (Condition #4) Edge whose length is, at least, a threshold value, for example, edge whose length is, at least, ½ of the height of the pattern.

In the example in FIG. 16A, only the section set basic matrix of section set No. “1” remains as the candidate, and the corresponding edge e1 is set as the edge of the candidate of the continuous line. More specifically, the section set basic matrix has the element number of “1” as stated above (Condition #1). Besides, as understood from the graph in the middle of FIG. 16A, the edge e1 extends substantially in the horizontal direction, and the ratio of the height of the edge to the width thereof is, at most, one (Condition #2). In addition, as understood from the graph, the edge e1 lies above the whole pattern, and the y-coordinate of the centroid of the edge lies within ⅓ on the upper side of the pattern (Condition #3). In addition, the length of the edge e1 is, at least, ½ of the height of the pattern (Condition #4). Accordingly, all the conditions are satisfied. Further, among the section set basic matrixes on the right side of FIG. 16B, the element number is “1” only in the matrix concerning the edge e1, the section set No. of which is “1”.

Next, the process of the candidate character lattice creation unit 15 shown in FIG. 9 will be stated in detail.

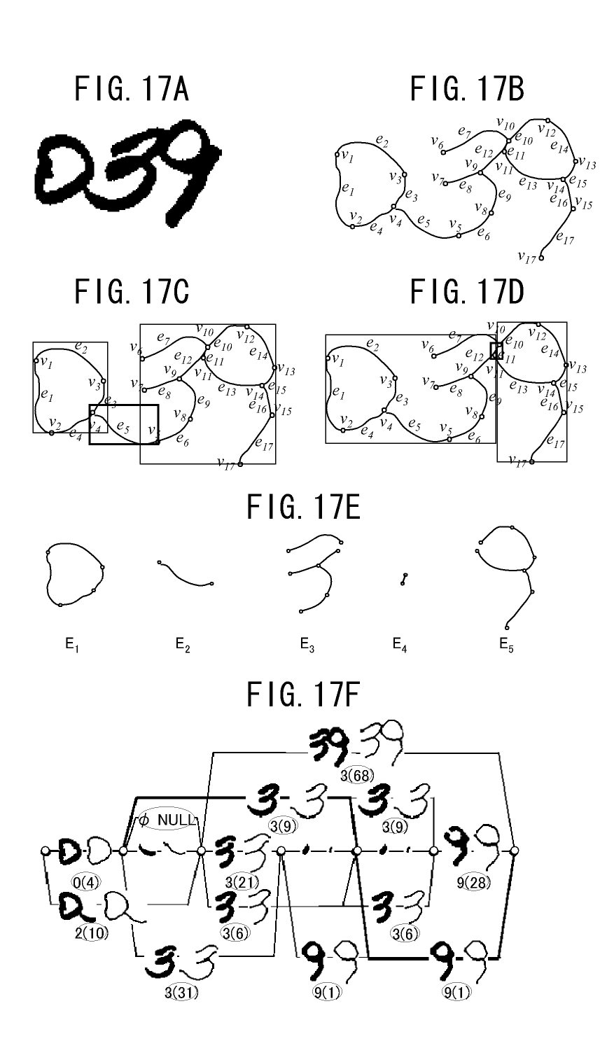

After all of the edges of the edge touching candidates, the edges of the point touching candidates and the edges of the continuous line candidates have been obtained by the above methods, the candidate character lattice creation unit 15 creates a candidate character lattice as stated below. (i) All of the edges of the edge touching candidates, the edges of the point touching candidates and the edges of the continuous line candidates are brought into partial sets each consisting of one edge, and the partial sets are arrayed in the ascending order of the x-coordinates of their respective circumscribed rectangles. Here, it is assumed that the partial sets exist n in total. (ii) As shown in FIG. 17E, the graph stated before is divided into the edges of the edge touching candidates, the edges of the point touching candidates and the edges of the continuous line candidates, and parts interposed between them, that is, partial sets of (2n+1) edges in total. (iii) The partial sets of the (2n+1) edges thus obtained are successively registered as the links between adjacent nodes. However, where the partial set of the edge corresponds to the edge of the edge touching candidate, the set of the same edge is registered twice as the link between the next adjacent nodes. That is, two links connected serially are provided as the links corresponding to the pertinent edge. Where the partial set of the edge corresponds to the edge of the continuous line candidate, a link which detours the link between the corresponding nodes is provided between these nodes, and φ (a blank set) is associated as the set of the edge. That is, a link is provided for a NULL image which is connected in parallel with the link of the pertinent edge. (iv) A start node s (s>0, s<n+1) and an end node t (t>s, t<n+1) are connected by a link, and those sets of edges with which the sets of edges existing between the start node and the end node are united are associated with respective links. However, a link is not generated for that set of edges whose size does not satisfy a predetermined condition. That is, in a case where the ratio of the width of the circumscribed rectangle of the set of edges to the height thereof becomes, at least, a threshold value, any link is not generated for the pertinent set of edges. (v) A pattern is restored from the respective sets of edges. The pattern (that is, the pattern in the state of the read image) is restored by, for example, a process in which a line-thinned pattern is created from edge information, and in which the line-thinned pattern is inflated half of a presumed character width. (vi) All the patterns thus restored are subjected to character recognition by an existing technique, and difference degrees themselves for obtained recognition character species (that is, the characters of recognition results) or recognition costs defined by the difference degrees are set as the weights of the links between the corresponding nodes.

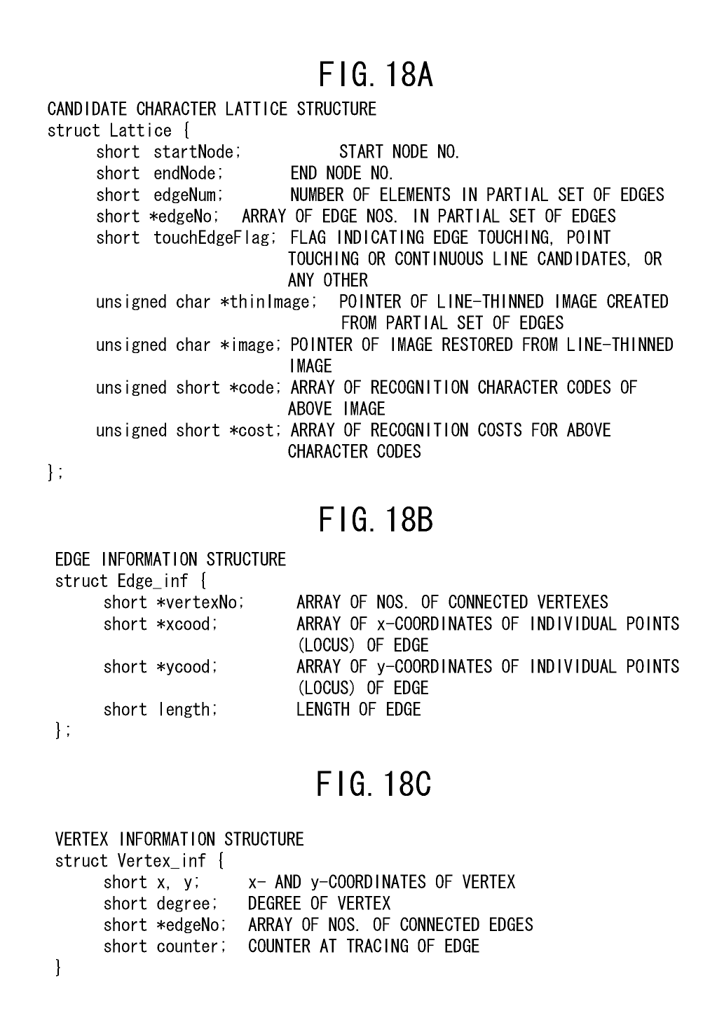

FIG. 17A shows the original pattern to-be-recognized read by a scanner. FIG. 17B shows a graph obtained from the original pattern. FIGS. 17C and 17D show situations where the graph has been divided by the edge e5 of the continuous line candidate and the edge e11 of the edge touching candidate obtained as stated above, respectively. FIG. 17E shows a situation where the whole graph has been divided into the partial sets of edges. FIG. 17F shows a candidate character lattice created as stated above. The candidate character lattice, edge information and vertex information are actually stored in structures as exemplified in FIGS. 18A to 18C, respectively.

Next, the process of the shortest path search unit 17 shown in FIG. 9 will be described.

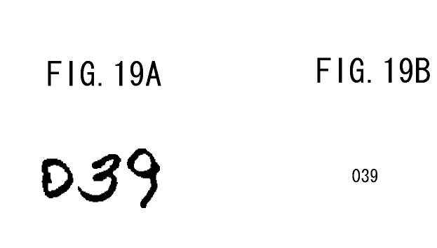

A path having the shortest distance is searched for from the candidate character lattice thus created, by a common technique such as the dynamic programming or the Dijkstra method. In consequence, the final recognition result of characters is obtained. In case of the examples in FIGS. 17A to 17F, as the result of the search for the shortest path, a path of node 1→node 2→node 5→node 7 is obtained as the shortest path on the candidate character lattice in FIG. 17F. Here, the nodes are indicated by black dots in the candidate character lattice as stated above, and their Nos. are allotted as 1, 2, . . . successively from the left. FIGS. 19A and 19B show the corresponding read image and the character codes of the recognition result corresponding to the shortest path (that is, numerals “039”), respectively.

FIG. 20 is a block diagram showing a configurational example of a computer in order to explain a case where the character recognition apparatus 10 in the foregoing embodiment is incarnated by the computer.

As shown in FIG. 20, the computer 500 includes a CPU 501 which executes instructions constituting a given program, thereby to perform various operations, and a manipulation unit 502 through which a user inputs manipulation contents or data with a keyboard, a mouse, etc. The computer 500 also includes a display unit 503 such as a CRT, a liquid-crystal display panel, or the like and which displays the process progresses, the processed results, etc. of the CPU 501 to the user. Also, the computer 500 includes a memory 504 which is made of a ROM, a RAM or the like, in which the program to be run by the CPU 504, data, etc. are stored, and which is used as a work area. Further, the computer 500 includes a hard disk drive 505 in which programs, data, etc. are stored. Still further, the computer 500 includes a CD-ROM drive 506 which loads programs and loads data from outside through a CD-ROM 507. Yet further, the computer 500 includes a modem 508 which serves for the download of a program from an external server, etc. through a communication network 509 such as the Internet or a LAN.

The computer 500 loads or downloads the program constituted by instructions for causing the CPU 501 to execute the processes which the above character recognition apparatus executes, through a computer-readable storage medium such as the CD-ROM 507 or through the communication network 509. In addition, the program is installed in the hard disk drive 505, it is appropriately loaded into the memory 504, and it is run by the CPU 501. As a result, the character recognition apparatus 10 is incarnated by the computer 500.

What is claimed is:

1. A computer-readable storage medium storing a character recognition program for causing a computer to function as:
division unit which divides a diagram into a plurality of parts on the basis of the diagram obtained from a slip surface in which a character string has been entered;
candidate character string acquisition unit which combines the plurality of parts of the diagram divided by the division unit, thereby to obtain a plurality of candidate character strings for the character string in the slip; and
character string selection unit which selects one character string from among the plurality of candidate character strings;
the candidate character string acquisition unit which includes at least one of first unit which duplicates a character line that touches adjacent characters and then includes the duplicated character line as an element of a candidate character string, and second unit which includes a candidate character string in which the touching character line between the adjacent characters has been removed, and a candidate character string in which the character line is contained, in the plurality of candidate character strings.

2. A computer-readable storage medium storing a program as defined in claim 1, wherein said first unit in the candidate character string acquisition unit includes in the plurality of candidate character strings, candidate character strings which cover a case where the touching character line between the adjacent characters belongs to one of the adjacent characters, a case where the character line belongs to the other character, and a case where the character line belongs to both adjacent characters.

3. A computer-readable storage medium storing a program as defined in claim 1, wherein:
the candidate character string acquisition unit includes path generation unit which associates respective parts obtained by dividing the diagram into the plurality of parts, with links between adjacent nodes, and generates a link between any nodes in a case where a pattern obtained by uniting a partial pattern included between the corresponding nodes becomes one character, and then associates the united pattern with the link, the links being connected with one another, thereby to generate paths which correspond respectively to the plurality of candidate character strings;
the character string selection unit includes:
character recognition cost setting unit which sets recognition costs required for character recognitions of the corresponding parts of the diagram, as weights for the respective links constituting the paths; and
path selection unit which selects one path as to which a recognition cost total obtained by totaling the weights of the respective links of every path becomes a minimum, as a path of said one character string;
said first unit in the candidate character string acquisition unit provides two links connected serially, as the links corresponding to the touching character line, and one of the two links has the touching character line, while the other line has the same touching character line as that of said one of the two links; and
said second unit in the candidate character string acquisition unit provides two links connected in parallel with the touching character line, as the links corresponding to the touching character line, and one of the two links has the touching character line, while the other link is a detouring link and has a blank pattern.

4. A computer-readable storage medium storing a program as defined in claim 1, wherein:
said first unit in the candidate character string acquisition unit is applied in a case where the touching character line extends along a direction substantially orthogonal to an extending direction of the character string; and
said second unit in the candidate character string acquisition unit is applied in a case where the touching character line extends along substantially the same direction as the extending direction of the character string.

5. A character recognition apparatus comprising:
division unit which divides a diagram into a plurality of parts on the basis of the diagram obtained from a slip surface in which a character string has been entered;
candidate character string acquisition unit which combines the plurality of parts of the diagram divided by said division unit, thereby to obtain a plurality of candidate character strings for the character string in the diagram; and
character string selection unit which selects one character string from among the plurality of candidate character strings;
wherein said candidate character string acquisition unit includes at least one of first unit which duplicates a character line that touches between adjacent characters and then includes the duplicated character line as an element of a candidate character string, and second unit which includes a candidate character string in which the touching character line has been removed, and a candidate character string in which the character line is contained, in the plurality of candidate character strings.

6. A character recognition apparatus as defined in claim 5, wherein said first unit in said candidate character string acquisition unit includes in the plurality of candidate character strings, candidate character strings which cover a case where the touching character line belongs to one of the adjacent characters, a case where the character line belongs to the other character, and a case where the character line belongs to both the adjacent characters.

7. A character recognition apparatus as defined in claim 5, wherein:
said candidate character string acquisition unit includes path generation unit which associates the plurality of parts of the diagram with links and connecting the links with one another, thereby to generate paths which correspond respectively to the plurality of candidate character strings;
said character string selection unit includes:
character recognition cost setting unit which sets recognition costs required for character recognitions of the corresponding parts of the diagram, as weights for the respective links constituting the paths; and
path selection unit which selects one path as to which a recognition cost total obtained by totaling the weights of the respective links every path becomes a minimum, as a path of said one character string;
said first unit in said candidate character string acquisition unit provides two links connected serially, as the links corresponding to the touching character line; and
said second unit in said candidate character string acquisition unit provides two links connected in parallel with the touching character line, as the links corresponding to the touching character line, and one of the two links has the touching character line, while the other link is a detouring link.

8. A character recognition apparatus as defined in claim 5, wherein:
said first unit in said candidate character string acquisition unit is applied in a case where the touching character line extends along a direction substantially orthogonal to an extending direction of the character string; and
said second unit in said candidate character string acquisition unit is applied in a case where the touching character line extends along substantially the same direction as the extending direction of the character string.

9. A character recognition method comprising:
a division step of dividing a diagram into a plurality of parts on the basis of the diagram obtained from a slip surface in which a character string has been entered;
a candidate character string acquisition step of combining the plurality of parts of the diagram divided at said division step, thereby to obtain a plurality of candidate character strings for the character string in the diagram; and
a character string selection step of selecting one character string from among the plurality of candidate character strings;
wherein said candidate character string acquisition step includes at least one of a first step of duplicating a character line that touches between adjacent characters and then including the duplicated character line as an element of a candidate character string, and a second step of including a candidate character string in which the touching character line between the adjacent characters has been removed, and a candidate character string in which the character line is contained, in the plurality of candidate character strings.

10. A character recognition method as defined in claim 9, wherein said first step in said candidate character string acquisition step includes in the plurality of candidate character strings, candidate character strings which cover a case where the touching character line belongs to one of the adjacent characters, a case where the touching character line belongs to the other character, and a case where the character line belongs to both adjacent characters.

11. A character recognition method as defined in claim 9, wherein:
said candidate character string acquisition step includes a path generation step of associating the plurality of parts of the diagram with links and connecting the links with one another, thereby to generate paths which correspond respectively to the plurality of candidate character strings;
said character string selection step includes:
a character recognition cost setting step of setting recognition costs required for character recognitions of the corresponding parts of the diagram, as weights for the respective links constituting the paths; and
a path selection step of selecting one path as to which a recognition cost total obtained by totaling the weights of the respective links every path becomes a minimum, as a path of said one character string;
said first step in said candidate character string acquisition step provides two links connected serially, as the links corresponding to the character line in the touch; and
said second step in said candidate character string acquisition step provides two links connected in parallel with the touching character line, as the links corresponding to the touching character line, and one of the two links has the touching character line, while the other link is a detouring link.

12. A character recognition method as defined in claim 9, wherein:
said first step in said candidate character string acquisition step is applied in a case where the touching character line extends along a direction substantially orthogonal to an extending direction of the character string; and
said second step in said candidate character string acquisition step is applied in a case where the touching character line extends along substantially the same direction as the extending direction of the character string.
